(19) United States
(12) Patent Application Publication
(10) Pub. No.: US 2010/0314862 A1
(43) Pub. Date: Dec. 16, 2010

(54) Quick tap connector

(76) Inventors: Chih-Yu Hsia, Arcadia, CA (US); Michael Jonathan Hsia, Arcada, CA (US); Patricia Shirley Hsia, Arcadia, CA (US)

Correspondence Address: WILLIAM W. HAEFLIGER, 201 S. LAKE AVE, SUITE 512, PASADENA, CA, 91101, US

(21) Appl. No.: 12/456,237

(22) Filed: Jun. 15, 2009

(51) Int. Cl. F16L 21/00; E03C 1/00

(52) U.S. Cl. 285/8

(57) ABSTRACT

For combination with a faucet having an upper surface, and a downward water outlet below the upper surface, the combination comprising a cup shaped flexible gasket that opens upwardly, the gasket having an annular wall adapted to interfit the faucet outlet, the gasket having a lower portion defining a discharge outlet and which is downwardly urged in response to water pressure entrains into the gasket via the faucet outlet, and means for releasably holding the gasket upwardly in annularly interfitting relation with the faucet outlet whereby the gasket annular wall seals against the faucet in response to the downwardly urging of the gasket.

### BACKGROUND OF THE INVENTION

1. Field of the Invention

This invention relates generally to water delivery devices connectible to faucets or aerators, and more particularly concerns sealing and clamping adaptation of such devices to such faucets.

Prior water delivery devices lacked the unusually advantageous features of structure, operation and improved results now provided by this invention.

People usually have to twist on something to make a connection of a branch pipe to an outlet of an existing conduit. Normally both the end of the branch pipe and the existing outlet have to have threads so that they can be twisted on together for the connection. A gasket is normally put between them to ensure non-leakage. However, this kind of connection is not only time consuming in using, to twist on or off with proper equipments, but also costly to make, because of tight tolerances involved in them. Thus, a quick and easy to use connector is needed.

### SUMMARY OF THE INVENTION

It is a major object of the invention to provide in combination with a faucet having an upper surface, and a downward water outlet below said upper surface, the following:

a) a cup shaped flexible gasket that opens upwardly, the gasket having an annular wall adapted to interfit the faucet outlet, the gasket having a lower portion defining a discharge outlet and which is downwardly urged in response to water pressure entering into the gasket via the faucet outlet,

b) and means for releasably holding the gasket upwardly in annularly interfitting relation with the faucet outlet, whereby the gasket annular wall seals against the faucet in response to such downward urging of the gasket.

Another object is to provide a manually operable clamping device that controllably exerts downward force against the faucet upper surface in response to such upward holding of the gasket. Such device may incorporate a pusher to engage the faucet upper surface, and a handle manually movable to displace the pusher downwardly, above the level of the gasket.

A further object is to provide an inverted U-shaped carrier threadably engaging the pusher, and having legs projecting downwardly to support the gasket therebetween, for tilting, to allow preliminary interfitting of the faucet outlet with the gasket wall.

An added object is to provide a gasket support pivotably carried by said device to allow initial tilting of the gasket to interfit the faucet outlet. That support may be pivotably carried by and between the device legs.

Yet another object is to provide a gasket that has an annular external surface that is downwardly tapered for wedging engagement with a device surface to create sealing force in response to water pressure exertion downwardly on a gasket internal lower surface.

As will be seen, a water pic conduit may be connected in series with the gasket discharge outlet.

Accordingly, the present invention provides a gasket connectible to the end of a branch pipe. The gasket can be easily strapped or clamped on an outlet of an existing conduit, which need not have threads. A portion of the gasket may have wedge shape-cross-sections which can be wedged securely between the exterior surface of the exiting outlet and the strapping or clamping device to create a positive seal so the connection will not leak. The wedging creating pulling forces are produced by the internal pressure inside the existing conduit acting on the body of the gasket. An alternate form of the current invention provides limits of movement of the gasket. By releasing the strapping or clamping device, the branch pipe and the existing conduit can be disconnected quickly. Basically, the current invention provided an infringed means to quickly connect or disconnect a branch pipe to an existing outlet, which needs not have threads.

These and other objects and advantages of the invention, as well as the details of an illustrative embodiment, will be more fully understood from the following specification and drawings, in which:

### DRAWING DESCRIPTION

FIG. 1 is an isometric view of the invented device. No hidden line is shown;

FIG. 2 is a front view of the device shown in FIG. 1. No hidden line is shown;

FIG. 3 is a side view of the device shown in FIG. 1. No hidden line is shown;

FIG. 4 illustrates the mounting of an assembly of the device shown in FIG. 1 onto an ordinary sink faucet with only a portion of the spout of the faucet being shown;

FIGS. 5 and 6 are sectional views of the device shown in FIG. 1. FIG. 5 shows the device mounted on an aerator of a sink faucet spout. FIG. 6 illustrates the pressure of the tap water pushed the gasket to create a positive seal against leakage. No hidden line is shown; and

FIG. 7 illustrates structure to create gasket sealing.

### GENERAL DESCRIPTION

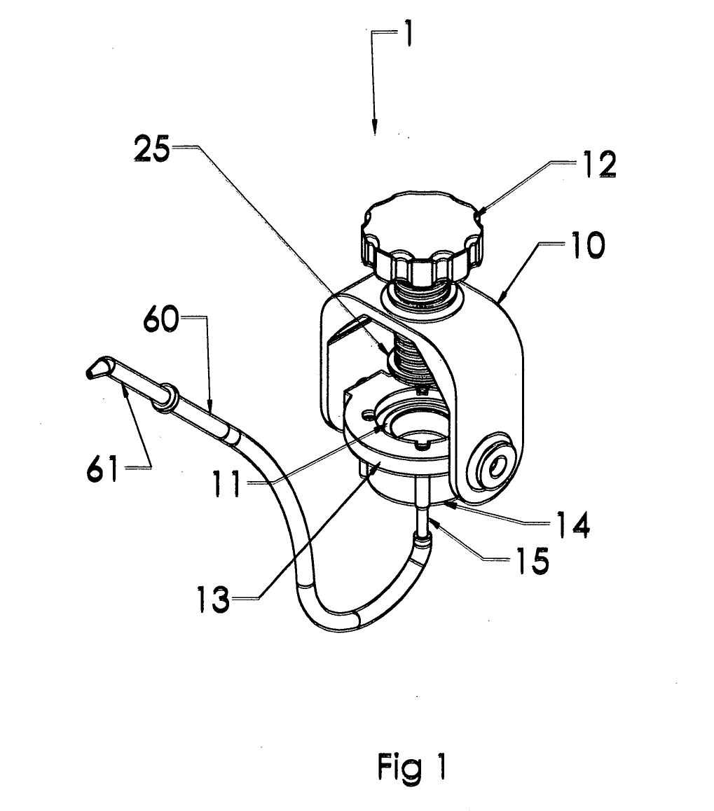

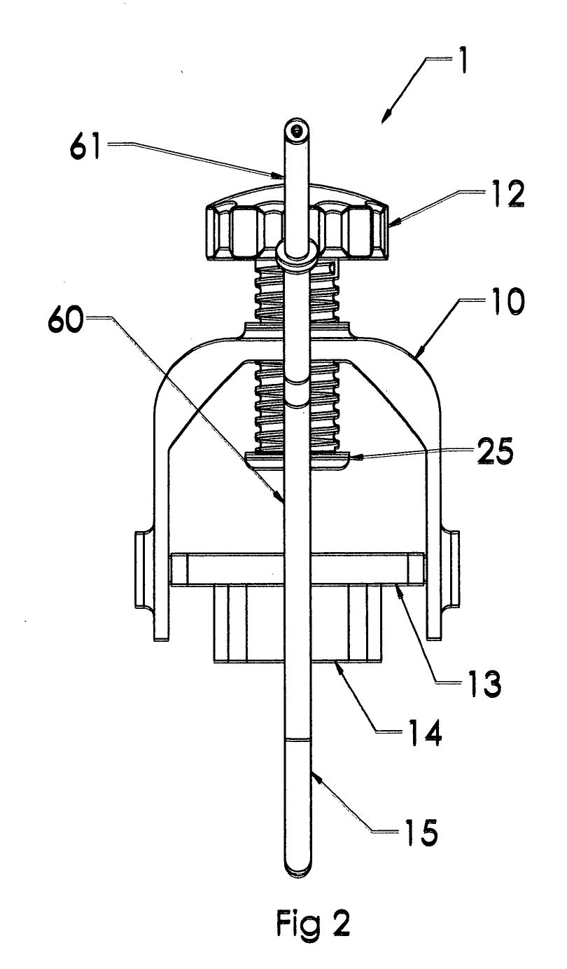

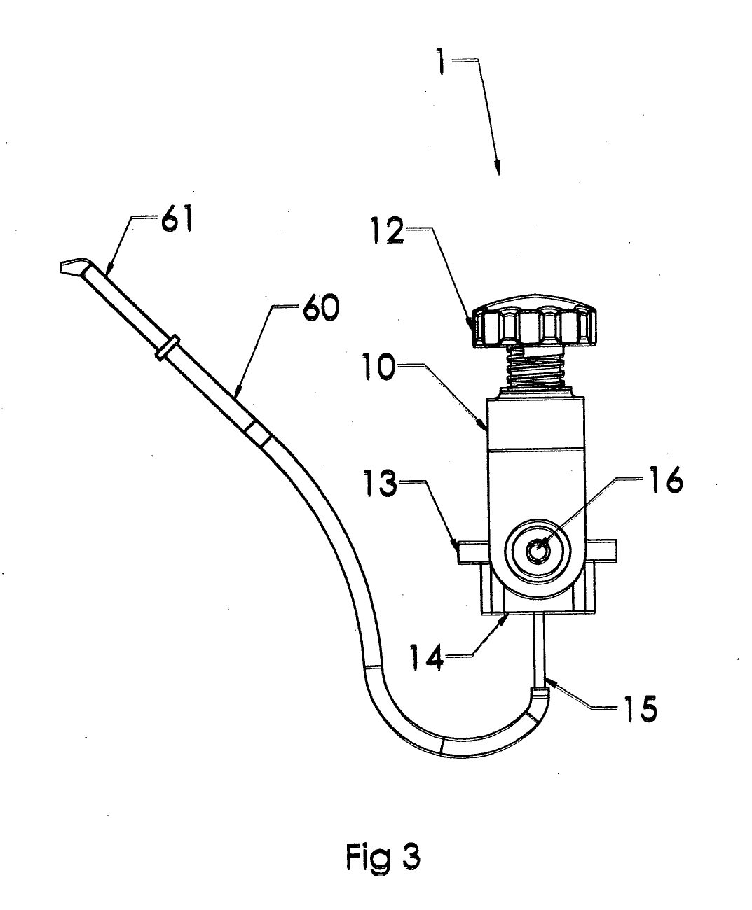

Referring to FIGS. 1, 2, 3 and 5, a quick tap connector 1 consists of a clamp 10 which has a screw with handle 12, a gasket 11, a swirl bracket 13, an optional restrainer 14, an outlet pipe 15, and an optional swirl or rotary pad 25. The swirl bracket is a plate which has a hole 22 in the center and two protruding swirl axes 16 on the edge. The clamp is a generally U-shaped clamp of which the screw with handle 12 can engage. The optional swirl pad 25 is a pad which is mounted at the end of the mounting screw which can be twisted i.e. rotated along the center line of the screw. Each of the two legs of the clamp has a hole on which the swirl axles 16 can be mounted. The swirl bracket can be pivoted or swirled at the holes on the two legs of the clamp. The gasket 11 resembles a basket or cup which has a wedge-shaped annular wall 17 with an optional enlarged rim 18. The gasket 11 has a protruding lower or bottom portion 19 which the outlet pipe 15 is connected to. The gasket is mounted on or in the through hole 22 of the swirl bracket 13, with a narrowed portion of the gasket in the hole. The optional restrainer 14 is a basket or cup which has a hole through which the outlet pipe can penetrate. The restrainer 14 can be mounted on or at the bottom of the swirl bracket 13.

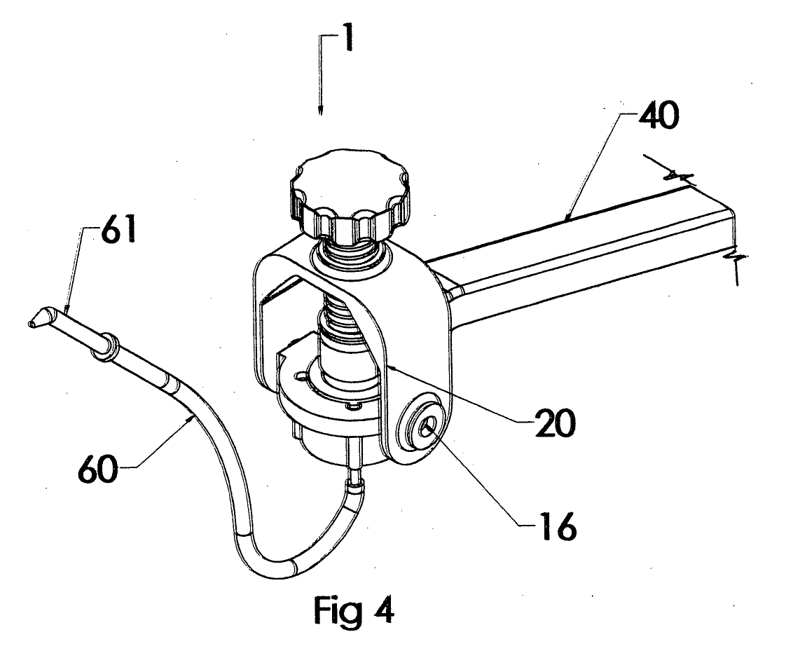

Referring to FIG. 4, before using the device, a user tilts the handle of the screw to enlarge the gap between the gasket and the end of the screw. Then the user assembles the swirl bracket to the gasket on an outlet of an existing conduit (in this case the aerator of the faucet). Then the user tilts the clamp so that the lower end of the screw of the clamp aligns with the exit conduit. The user then turns the handle of the screw to tightly fasten the device onto the top surface of the faucet outlet. The connection then is ready for use. After such use, the user can unclamp the device and remove it from the outlet faucet. The tube 60 and the nozzle 61 illustrate the possible use of the invented devices, as for a water pic.

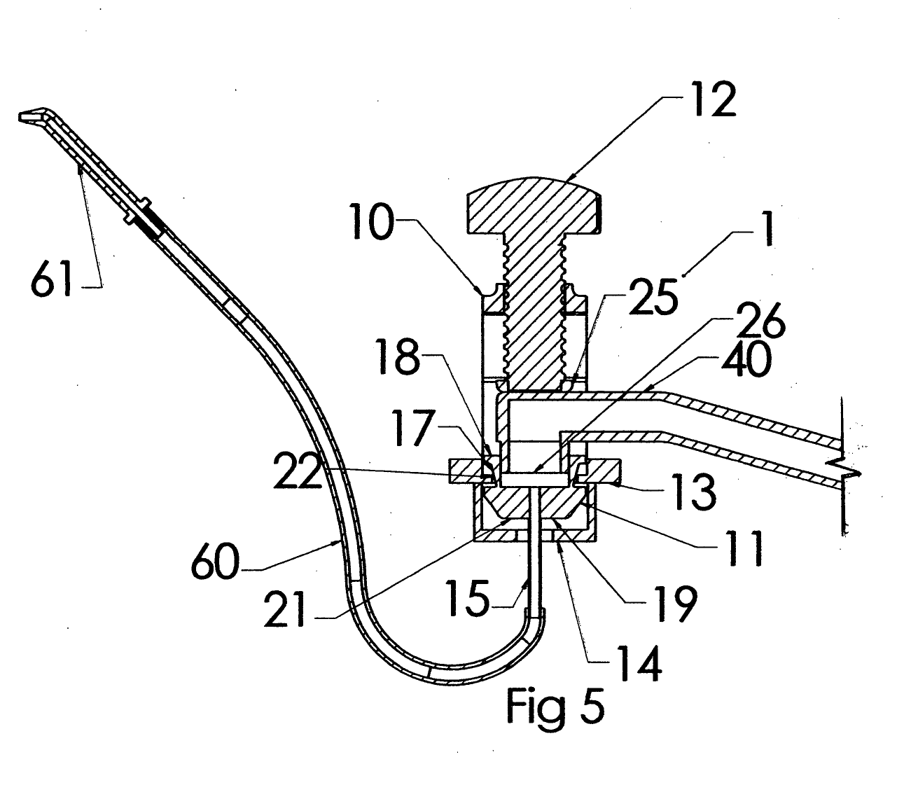

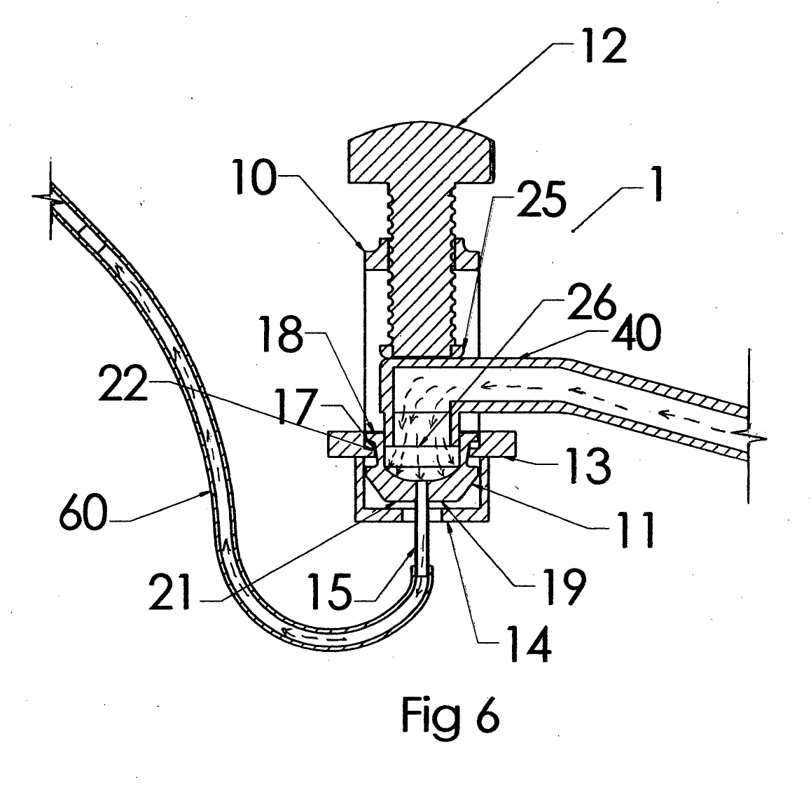

Referring to FIG. 5 and FIG. 6, the swirl bracket can be swirled such that the center of the gasket can be aligned with the center of the outlet (the aerator of the faucet). The rim 26 of the outlet will locate over the middle of the gasket when the device is clamped on the faucet 40. When the water is turned on, the pressure of the water will push the gasket downwardly away from the outlet (illustrated as dashed arrow lines in FIG. 6). The deflected movement of the gasket acts to pull the wedge-shaped gasket wall against the edge of the hole 22. The wedge-shaped wall also will force the gasket tightly against the exterior wall of the outlet. This tightness will create positive seal against leakage. The higher the water pressure, the greater the deflected movement of the gasket will be. Because of the wedge-shaped wall, the larger the gasket movement, the tighter the seal.

In order to prevent the gasket from being blown away, a restrainer 14 can be used. The optional enlarged rim of the gasket can also provide limitations on the movements of the gasket. When the water is turned on and the pressure is released, the device can be unclamped and removed. In order to prevent the gasket from being pulled out of the hole 22, the protruding bottom 19 is provided. The protruding bottom can work against the wall of the hole 22 so that the gasket will not be pulled out of the device and detached from the outlet of the conduit.

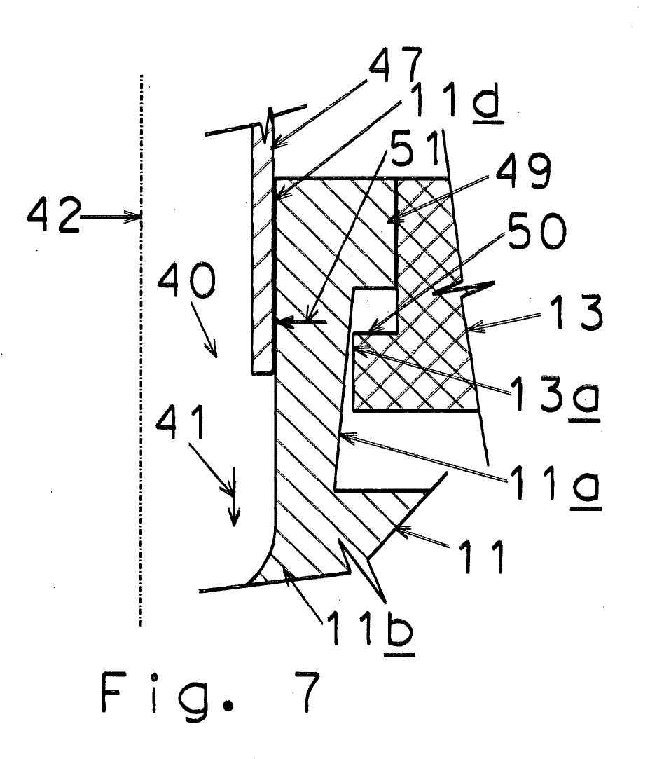

FIG. 7 illustrates in greater detail, the sealing principles.

The gasket 11 has a downwardly tapered annular outer surface 11a facing outwardly toward an annular inner edge 13a of the carrier or bracket 13. As water pressure in the gasket central cavity 40 increases, the lower transverse extent 11b of the gasket acts as a piston, against which water pressure or force is exerted. See arrows 41. Such pressure tends to urge the gasket extent 11b downwardly, pulling the gasket annular wall 11a downwardly. This effects wedging engagement of gasket tapered surface 11a sealingly against the edge 13a, which in turn tends to deflect the gasket inner annular wall 11d radially inwardly toward gasket axis 42. See arrow 51. Sealingly pressure is thereby generated as 11d is urged against the faucet spout annular wall 47, projecting downwardly. The gasket is returned, axially, by radially enlarged annular rim 49, above carrier seat 50.

The foregoing is considered as illustrative only of the principles of the invention. Furthermore, since numerous modifications and changes will readily occur to those skilled in the art, it is not desired to limit the invention to the exact construction and operation shown and described, and accordingly all suitable modifications and equivalents, may be resorted to, falling within the scope of the invention as claimed

We claim:

1. For combination with a faucet having an upper surface, and a downward water outlet below said upper surface, the combination comprising
a) a cup shaped flexible gasket that opens upwardly, the gasket having an annular wall adapted to interfit the faucet outlet, the gasket having a lower portion defining a discharge outlet and which is downwardly urged in response to water pressure entrains into the gasket via the faucet outlet,
b) and means for releasably holding the gasket upwardly in annularly interfitting relation with the faucet outlet whereby the gasket annular wall seals against the faucet in response to said downwardly urging of the gasket.

2. The combination of claim 1 wherein said means includes a manually operable clamping device that controllably exerts downward force against the faucet upper surface in response to said upward holders of the gasket.

3. The combination of claim 2 wherein said device includes a pusher to engage the faucet upper surface, and a handle manually movable to displace the pusher downwardly, above the level of the gasket.

4. The combination of claim 3 including an inverted U-shaped carrier threadably engaging the pusher, and having legs projecting downwardly to support the gasket therebetween, for tilting to allow interfitting of the faucet outlet with the gasket wall.

5. The combination of claim 4 including a gasket support pivotably carried by said device to allow initial tilting of the gasket to interfit the faucet outlet.

6. The combination of claim 4 including a gasket support pivotably carried by said device to allow initial tilting of the gasket to interfit the faucet outlet, said support pivotably carried by and between said legs.

7. The combination of claim 1 wherein the gasket has an annular external surface that is downwardly tapered for wedging engagement with a device surface to create sealing force in response to water pressure exertion downwardly on a gasket internal lower surface.

8. The combination of claim 1 including a gasket support pivotably carried by said device to allow initial tilting of the gasket to interfit the faucet outlet, and wherein the gasket has an annular external surface that is downwardly tapered for wedging engagement with a device surface to create sealing force in response to water pressure exertion downwardly on a gasket internal lower surface.

9. The combination of claim 1 including a water pic conduit connected in series with said gasket discharge outlets.

10. A quick tap connector comprising:
a) a basket-like gasket which penetrates through a hole of a base which is mounted on a clamping means;
b) said base carried to pivot on said clamping means;
c) said gasket having a wedge-shaped side wall and an outlet at its bottom;
d) said clamping means operable to clamp said gasket onto an outlet of an existing conduit.

11. A quick tap connector of claim 10 wherein said base has a restrainer connected therewith, and which limits water pressure induced movement of said basket-like gasket.

12. A quick tap connector of claim 10 wherein said clamping means comprises a U-shaped bracket with a screw and a handle.

13. A quick tap connector of claim 12 wherein said screw has a pressure plate which can be turned at the end of said screw.

14. A quick tap connector of claim 10 wherein said basket-like gasket has a thickened rim.

15. A quick tap connector of claim 10 wherein said bottom of said gasket has a rim extending from said wedge-shaped wall.

16. A quick tap connector, comprising
a) a U-shaped carrier having an arched portion and two legs,
b) a screw having threaded engagement with said arched portion and extending intermediate said legs, there being a handle on the screw to rotate it,
c) a cup-shaped sealing gasket carried by said legs to be axially movable and defining a cavity facing the screw, the gasket being axially bodily movable relative to said leg,
d) a sealing surface carried by said legs to be engaged by the gasket as it is bodily moved,
e) and means including said gasket to seal off about an aerator in response to turning of the handle and rotation of the screw to displace the gasket, bodily.

17. The combination of claim 1 including a strainer extending below the gasket lower portion, and through which an outlet pipes extends from the gasket lower portion.
